(19) United States
(12) Patent Application Publication
(10) Pub. No.: US 2002/0066702 A1
(43) Pub. Date: Jun. 6, 2002

(54) Antibacterial and antibiofilm bonded permanent magnets

(76) Inventor: Jinfang Liu, Lancaster, PA (US)

Correspondence Address: BANNER & WITCOFF, LTD., 28 STATE STREET, 28th FLOOR, BOSTON, MA, 02109, US

(21) Appl. No.: 09/972,738

(22) Filed: Oct. 5, 2001

Related U.S. Application Data
(60) Provisional application No. 60/183,941, filed on Feb. 22, 2000.

(51) Int. Cl. B03C 1/30; C02F 1/48; B01D 35/06; C23F 11/18; H01F 1/00; H01F 1/26; C04B 35/04; H01F 7/02; H01F 1/04; H01F 1/14; B22F 3/00; C04B 35/64

(52) U.S. Cl. 210/695; 422/19; 335/302; 252/62.54; 252/62.55

(57) ABSTRACT

A class of antibacterial and antibiofilm bonded permanent magnets having: superior (BH)ₘₐₓ comprising: permanent magnet particulate, binder and a cationic antibacterial and antibiofilm substance responsive to the magnetic field of said magnet.

### CROSS REFERENCE TO RELATED APPLICATION

This application claims priority from a copending U.S. Provisional Application, Ser. No. 60/239,381 filed Oct. 11, 2000. This application is also related to U.S. patent application, Ser. No. 09/782,508, filed Feb. 13, 2000 and entitled: Density Enhanced DMC Bonded Permanent Magnets. The teachings of these applications are hereby incorporated herein by reference.

### BACKGROUND OF THE INVENTION

In the U.S., biofilms are reported to be involved in 65% of all human, bacteria-based infections according to the U.S. Center for Disease Control and Prevention in Atlanta, Ga. It is further estimated that approximately 5% of those patients who annually receive shunts, catheters, stents and similar invasive devices, develop serious biofilm based infections or blockages.

Typical antimicrobial and antibiotic treatments for these biofilm based infections, inflammations, blockages, etc., run the risk of developing antimicrobial and antibiotic resistant strains of bacteria. The net is, biofilm based bacterial infections associated with invasive devices pose a major unmet health need in the U.S. Biofilm based industrial slimes also pose major problems for various industrial processes.

The present invention provides: a novel bonded permanent magnet composition with antibacterial/ antibiofilm properties, a process for manufacturing these antibacterial and antibiofilm bonded magnets; as well as the use of these antibacterial and antibiofilm bonded permanent magnets to treat bacteria influenced conditions, including those associated with invasive devices, biofilms, industrial slime, etc.

Cations of various substances have been shown to exhibit antibacterial properties in a wide range of applications. These include silver, iodine, copper, zinc, mercury, tin, lead, bismuth, cadmium and chromium cations, where the cation is chelated, complexed, ion exchanged and/or physically caged in some kind of supporting substance such as silver zeolite. Antibacterial cations in a variety of products and/or processes are described in the following U.S. Patents: U.S. Pat. Nos. 4,755,585; 4,959,268; 5,180,585; 4,906,466; 4,888,118; 5,302,385; 5,051,256; 6,025,446; 6,102,205; 5,900,258 and 3,408,295. These antibacterial cation substances also function as antibiofilm substances in most applications. All of the foregoing U.S. Patents are incorporated by referenced into the teaching of the present invention.

The various cation based antibacterial and antibiofilm compositions of the prior art have well documented limitations with respect to their antibacterial and antibiofilm effectiveness, longevity, reliability, etc., which has dramatically restricted their commercial applications.

### SUMMARY OF THE INVENTION

The primary object of the invention is to enhance the antibacterial and antibiofilm properties of various cationic substances with various bonded permanent magnets, wherein these cationic substances are responsive to the magnetic field of said magnet.

Another object of the invention is to provide a novel process for manufacturing bonded permanent magnets containing cations with enhanced antibacterial and antibiofilm properties.

Another object of the invention is to provide a novel process for manufacturing bonded permanent magnets provided with an external source of cations with enhanced antibacterial and antibiofilm properties.

A further object of the invention is to provide a novel antibacterial and antibiofilm treatment for bacteria influenced conditions using enhanced cation substance based, antibacterial and antibiofilm bonded permanent magnets in a wide range of medical and industrial devices.

Another object of the invention is to provide novel biofilm treatments using cation antibacterial and antibiofilm based, bonded permanent magnets in a wide range of industrial and medical devices and products.

Yet another object of the invention is to provide novel biofilm therapy using cation antibacterial based bonded permanent magnet medical devices.

Still another object of the invention is to provide bacteria resistance-free means that are alternatives to antibiotics and antimicrobials and suitable for controlling bacterial infections without adverse side effects.

### BRIEF DESCRIPTION OF THE DRAWINGS

FIG. 1 is a perspective diagrammatic view illustrating a structure and method for dynamic magnetic compaction (DMC) of permanent magnet particulates, various binders, and various cationic antibacterial and antibiofilm substances into high density bonded permanent magnets with enhanced antibacterial and antibiofilm properties.

FIGS. 2A-2B are perspective and cross-sectional views of a DMC bonded permanent magnet containing permanent magnet particulates, binders and cationic antibacterial substances.

FIGS. 3A through 3J are perspective views of bonded permanent magnet stents containing permanent magnet particulates and binders in various arrangements exhibiting magnetic field controlled cations with various flux paths.

FIG. 4 is a perspective, diagrammatic view of an industrial process with a slime control means.

FIG. 4A is a perspective view of slime control means in said process using bonded magnets of the invention.

FIG. 5 is a chart illustrating iodine levels of various antibacterial and antibiofilm systems.

FIG. 6A through 6C are cross-sectional views of various bonded magnet wraps containing cationic substances.

### DETAILED DESCRIPTION OF THE PREFERRED EMBODIMENTS

New classes of antibacterial bonded permanent magnets have been developed that have an antibacterial and/or antibiofilm zone characterized by:

a. superior (BH)ₘₐₓ

b. a binder that is not altered during magnet formation,

c. a controllable antibacterial and antibiofilm cationic substance which imparts enhanced antibacterial and antibiofilm properties to said magnet,

d. a void ratio approaching 0%,

e. a structure that is not altered during fabrication, and

f. enhanced antibacterial and antibiofilm properties responsive to the magnetic field of the bonded permanent magnet.

The antibacterial and antibiofilm bonded permanent magnets of the present invention contain:

permanent magnet particulates,

binder(s), and

antibacterial and antibiofilm cationic substances that exhibit enhanced antibacterial and antibiofilm activity when fabricated into a bonded permanent magnet. Such bonded magnets exhibit an antibacterial and antibiofilm zone that extends beyond the magnet for the life of the magnet.

In one embodiment, the antibacterial and antibiofilm bonded permanent magnets of the invention having enhanced antibacterial and antibiofilm properties, are electromagnetic-pulse-compacted. That is, a mixture of permanent magnet particulates, binders and antibacterial cationic substances are compacted by pulsed electromagnetic forces where each pulse has a pulse time less than the thermal constant of the permanent magnet particulate and said compaction is achieved without adversely altering the structure of the permanent magnet particulates, the binder or the antibacterial and antibiofilm properties of the cationic substance(s).

The bonded permanent magnets of the present invention exhibit enhanced antibacterial and antibiofilm properties when they are pulsed-electromagnetic-compacted using permanent magnet particles having a thermal time constant, which is related to:

the size of permanent magnet particulate particles

the thermal conductivity of said particles

the heat capacity of said particles

the density of said particles, according to the following:

T=DC/KR²

where T represents the thermal time constant, D represents the density, C represents the heat capacity, K represents the thermal conductivity and R represents the size of the particle. For example, when the pulse time of applied magnetic pressure is less than the thermal time constant of the permanent magnet particles, greater compressibility of the compressed particle is obtained.

In a particularly preferred embodiment of the present invention, the enhanced, antibacterial/antibiofilm bonded permanent magnets of the present invention exhibit unexpected and unobvious anti-biofilm properties. The resistance to biofilm formation exhibited by the bonded permanent magnets of the present invention is most surprising and is particularly useful in those situations where control of biofilm formation is helpful in controlling and/or influencing chronic health conditions, i.e., buildup of plaque and/or biofilms in stents of heart disease patients or in other invasive devices. Equally as useful is the control of various adverse environmental conditions such as biofilm based corrosion, slime formation, etc.

Various industrial processes that are slime limited are particularly suitable for the introduction of slime control bonded permanent magnets. These unobtrusive devices emit an ongoing flow of antibacterial and/or antibiofilm ions that are released continuously over the life of the bonded permanent magnets to inhibit the formation of slime, i.e., the initial and most pervasive phase of biofilm interference that pervades various industrial processes today.

### MECHANISM OF ACTION

While not wishing to be bound by theory, it is proposed that the antibacterial and antibiofilm zone of activity exhibited by the bonded permanent magnets of the present invention is attributed to ions of the cationic antibacterial/antibiofilm substance incorporated into the bonded magnet. It is proposed that these ions follow the magnetic field created by the bonded permanent magnet, thereby establishing a bioactive antibacterial and antibiofilm zone around the magnet. Thus, this zone of bioactivity is correlated to the magnetic field of the particular bonded magnet. The level of antibacterial and/or antibiofilm activity from a specific cation substance is correlated with the quantity of the cationic substance in the bonded magnet and the magnetic field of the magnet.

The chemical force, F_{c}, on the cationic antibacterial and antibiofilm substances relies on diffusion and gradients in concentration of specific cations to affect flow from a high concentration of cations to a lower concentration of cations. This chemical, F_{c}, is enhanced and/or controlled by the magnetic force on these cations attributed to the bonded permanent magnet, F_{M}, resulting in the cations flowing faster when F_{c} and F_{M} are in sync and in the same direction, and slower when these two forces are in opposition.

The cations suitable as a source of antibacterial and antibiofilm activity are generally in a chelated, complexed, physically caged or ion exchange state as these terms are defined in U.S. Pat. Nos. 4,775,585; 4,959,268; 5,180,585; 4,888,118, and Canadian Patent 1,119,748.

Generally, this complexed state of the cation in the bonded magnet for the purposes of the present invention is described as an excited state. The (BH)ₘₐₓ of the bonded magnet controls the rate at which these excited cations break away from their complex and diffuse to the bacteria and/or biofilm being treated.

For the purposes of the present invention, the term antibacterial includes bacteriostatic, antimicrobial and other means of controlling and/or preventing microbial growth and/or bacterial cell growth. For the purpose of the present invention, the term antibiofilm includes all means of controlling biofilm formation and growth.

By the term bacteria is meant eubacteria and archaebacteria. Eubacteria include fermicutes, gracilicutes and ternicutes. Gracilicutes include gram-negative, facultatively anaerobic rods. Gram-negative, facultatively anaerobic rods include Enterobacteriaceae. Enterobacteriaceae include Klebsiella and Escherichia. Klebsiella include Klebsiella pneumonia and Escherichia include Escherichia coli. Fermicutes include the group gram-positive cocci, and the group endospore-forming rods and cocci. Gram-positive cocci include Micrococcaceae. Micrococcacea include Staphylococcus and Staphylococcus includes Staphylococcus aureus. Endospore-forming rods and cocci include Bacillaceae. Bacillaceae includes Bacillus, which includes Bacillus circulans. All references herein to bacteria are in accordance with Bergey's Manual of Systematic Bacteriology, Williams & Wilkens, 1^{st} ed. Vol. 1-4 (1984).

The term Myceteae includes Amastigomycota. Amastigomycota include Deuteromycotina, which includes Deuteromycetes. Deuteromycetes include Ascergillis and Candida. Aspergillis includes Aspergillis niger and Candida includes Candida albicans.

The term virus includes bacteriophage. Bacteriophage includes T-series bacteriophage that includes T-even bacteriophage such as bacteriophage T4.

The term antimicrobial agent refers to agents that destroy microbes (i.e., bacteria, fungi, viruses and microbial spores) thereby preventing their development and pathogenic action.

Methods used to measure the antibacterial and antibiofilm properties of various cations such as the silver cations contained in various silver zeolites, as well as iodine and other cations disclosed above, are described in U.S. Pat. No. 5,900,258 and the references and teachings cited therein, as well as the references cited previously; all of which are incorporated by reference herein.

For the purposes of the present invention, bonded permanent magnets include rare earth magnets where the rare earth magnetic particulate is combined with binders followed by compacting, extruding, calendaring, injection and/or compression molding the mixture into the desired shape. Both magnetically isotropic and anisotropic bonded permanent magnets are included in the definition of bonded permanent magnets suitable for the present invention. Calendering and extrusion are preferred. Further details on bonded permanent magnets and particularly dynamic magnetically compacted bonded permanent magnets are provided in copending application, Ser. No. 60/183,941.

The discovery and evolution of rare earth permanent magnet particulates suitable for use in bonded permanent magnets are chronicled in global conference series, which include International Workshops on Rare Earth Magnets and their Applications, MMM (Magnetism and Magnetic Materials) conferences, INTERMAG (International Magnetic Conferences) and other conferences held from 1964 through 1999. The proceedings of these conferences are hereby incorporated by reference. In addition, the following U.S. Patents are relevant and are also incorporated herein by reference: 4,210,471; 4,213,803; 4,284,440; 4,289,549; 4,497,672; 4,536,233; 4,565,587; 4,746,378; 5,781,843; 3,748,193; 3,947,295; 3,970,484; 3,977,917; 4,172,717; 4,211,585; 4,221,613; 4,375,996; 4,382,061; and 4,578,125.

Bonded permanent magnets of the present invention have superior densities, i.e., maximum energy product (BH)ₘₐₓ. It has been observed that the higher the (BH)ₘₐₓ, the more energy available to enhance the antibacterial properties of the cation substance.

One measure of the resistance of a magnet to demagnetization (and the corresponding reduction in antibacterial property enhancement) is intrinsic coercivity, _{I}H_{C}. This resistance to demagnetization is particularly important for the bonded permanent magnets of the present invention having enhanced antibacterial and antibiofilm properties.

Iodine is a particularly preferred cation suitable as a source of antibacterial and antibiofilm activity in the bonded permanent magnets of the present invention. Iodine is a well-known germicide with activity against a wide range of bacteria, viruses and biofilms. Various polymeric materials form complexes with iodine. These are described as iodophors. See U.S. Pat. Nos. 3,235,446; 4,381,380; 5,302,385; 4,642,267; 4,373,009; 4,769,013; 4,374,126 and 5,051,256.

Iodine has long been recognized as an antimicrobial agent with outstanding effectiveness against a wide range of microorganisms including Gram positive and Gram-negative bacteria, mycobacteria, fungi, protozoa and viruses. It remains effectiveness over a wide pH range and, unlike a large majority of other antimicrobial agents; proteins in the wound fluid/serum do not readily inactivate it. Iodine readily penetrates microbial cell walls and is believed to exert its biocidal activity through a number of interactions including the following:

1. Oxidation of sulfhydryl groups in enzymes and proteins;

2. Inactivation by iodination of phenolic groups in amino acids and proteins;

3. Iodination of basic —NH— groups in amino acids and nucleotides that serve as critical hydrogen bonding sites;

4. Iodination of unsaturated lipids/fatty acids leading to membrane immobilization.

As used in the art, the term available iodine refers to any form of iodine that has oxidizing capacity. Such forms are titratable with sodium thiosulfate and include elemental iodine, triiodide ion, hypoiodite ion, and iodateion.

In a typical aqueous iodine solution, e.g., a solution containing 2% w/v iodine (I₂) and 2.4% sodium iodide (NaI), the available iodine exists in several species in equilibrium with each other. The species include elemental iodine (I₂), hypoiodic acid (HOI), hypoiodite ion (OI⁺), hydrated iodine cation (H₂OI⁺), iodite ion [IO₃]⁺ and triiodide ion [I³]⁺. Most antiseptic formulations, and the aqueous environment of wounds to which they are applied, have a pH range of 3 to 9. In this pH range of 3 to 9, the concentrations of hydrated iodine cation, hypoiodite ion, and iodate ion are so low that they can be essentially neglected. Tri-iodide ion readily dissociates into elemental iodine and iodide ion in highly diluted solution. Thus, the primary active species in highly diluted aqueous iodine solution are elemental iodine, i.e., I₂, and hypoiodic acid, i.e., HOI, in equilibrium. The relative proportions of the two species depend on the pH and the available iodine content. Concentrations of free iodine as low as 0.5 to 2 ppm exhibit antimicrobial effect. The term free iodine refers to available iodine that is not bound to another chemical substance such as a polymer or surfactant.

Tincture of iodine, which is a hydro-alcoholic solution of elemental iodine (I₂) and sodium iodide (NaI), is well recognized as a degerming antiseptic and has been in use for presurgical prepping of skin for over one hundred years. However, it is highly irritating, corrosive and toxic when in contact with a body cavity, mucus membranes or wounds. It also has other undesirable effects that make it unsuitable for wound treatment. These include potential for occasional hypersensitivity reactions, skin staining and unpleasant odor.

Major advances in utilizing the antimicrobial efficacy of iodine while minimizing its tissue toxicity and other undesirable side effects were made with the advent of iodophors. Iodophors are readily dissociable, loose complexes of tri-iodide or iodine with polymers or surfactants. Iodophors not only increase the solubility of iodine in aqueous media, but also reduce its chemical potential and vapor pressure, thereby reducing its undesirable side effects. The iodophors serve as reservoirs of iodine and function by slowly releasing iodine at the site of application. A well-known and very widely used iodophor is polyvinylpyrrolidone-iodine complex, which is also known as PVP-iodine. Since the term Povidone is an art recognized synonym for polyvinylpyrrolidone, it will be understood that the term Povidone-iodine is synonymous with, and an alternative way of referring to, a polyvinylpyrrolidone-iodine complex. Its available iodine content ranges between 9% and 12%. Spectroscopic studies by Schenck et. al., reported in Structure of polyvinylpyrrolidone-iodine, J. Pharm. Sci., 68, p. 1505-1509, 1979, indicate that Povidone-iodine consists of adjacent pyrrolidone units complexed with hydrogen tri-iodide rather than elemental iodine. Therefore, only two thirds of its entire iodine content constitutes available iodine. One-third of the entire iodine in this complex is in the unavailable iodide form.

Povidone-iodine is utilized in commercially available disinfectant products such as Betadine and Isodine that are widely used in hospitals for prepping of skin prior to surgery and as surgical scrubs and hand washes for health care personnel hand washes.

Although they are useful for application to intact skin, iodophor solutions as well as most other topically effective antimicrobial preparations based on quaternary ammonium salts or chlorhexidine salts are not well suited for use on wounds. In these preparations, all of the antimicrobially active content is in solution and in direct contact with the wound. Furthermore, in order to be effective over an extended period of time, the concentrations of the active agents far exceed minimum inhibitory concentrations by several orders of magnitude. At these concentrations, the active agents exert cytotoxic, cytopathic or cytostatic effects on the wound tissue as well as on cells, such as fibroblasts, involved in the wound repair process. As a result, the wound repair process is significantly and undesirably retarded.

Lineaweaver et al., Topical antimicrobial toxicity; Arch. Surgery, 120, p. 267-270, 1985, found in human fibroblast tissue culture studies that no fibroblasts survived 24 hours after a 15 minute exposure to 1% povidone-iodine, 3% hydrogen peroxide or 0.5% sodium hypochlorite. These studies also showed that the cytotoxicity threshold concentration of soluble povidone-iodine was below 0.01% and above 0.001%. It was also found that re-epithelialization of full thickness dermal wounds on the backs of rats was substantially and statistically significantly inhibited at eight days after initial irrigation with 1% povidone-iodine or with 0.5% sodium hypochlorite.

Rosso, in U.S. Pat. No. 4,323,557 describes adhesives containing N-vinylpyrrolidone in the polymer backbone. In these adhesives, iodine complexing, monomeric units of vinylpyrrolidone are co-polymerized with other adhesive co-monomers. Therefore, the iodine complexing N-vinylpyrrolidone units in this polymeric adhesive are rendered water-soluble. Pressure sensitive films with such adhesives can be complexed with iodine for providing its slow release. These compositions can be used as antimicrobial surgical drapes. However, they cannot be used on wound surface due to the risk of physical reinjury to the healing wound tissues from direct contact with the adhesive.

Shih, in U.S. Pat. No. 5,242,985 describes a complex of a strongly swellable, moderately crosslink polyvinylpyrrolidone and iodine. The composition is capable of releasing iodine substantially uniformly over a 6-hour period in the presence of water. Shihs complex is prepared by a method that employs a particular type of crosslinked polyvinylpyrrolidone described in his earlier U.S. Pat. No. 5,073,614. Shih defines narrower ranges for its characteristics (aqueous gel volume, Bookfield viscosity and crosslinker concentration) required for the iodine complex. Shih's iodine complexes are prepared by moistening the specific powdered crosslinked polyvinylpyrrolidone with a small amount of isopropanol or isopropanol/water mixture, mixing the moistened crosslinked polyvinylpyrrolidone with approximately 20%, based on the weight of the PVP polymer of iodine at room temperature, and then heating it at 45° C. for two hours and then at 90° C. for 16 hours. The resulting PVP/iodine complex is a light yellow, free flowing fine powder containing approximately 10% available iodine and approximately 5% iodide.

The Shih complex releases its available iodine at a uniform rate over a six-hour period. In view of this uniform rate of release, the concentration of soluble, available iodine at the wound site will exceed cytotoxic levels within a relatively short period of time, e.g., a few hours, after application of the Shih complex to a wound. This means that use of the Shih material will, at some point in time, undesirable result in wound irritation and/or retardation of wound healing. Those skilled in the art will also notice that nearly one fourth of the iodine used in the preparation of the complex described by Shih et al. is unaccounted for and another one fourth is reduced to iodide. This strongly indicates that the starting polymer, i.e., crosslinked polyvinylpyrrolidone, is partially oxidized by iodine during the preparation of the complex under the processing conditions used for iodination. Without wishing to be bound by any particular theory, it is thought that this partial oxidation may account for the observed uniform release pattern of available iodine into the aqueous environment. Although the compositions described in Shih's U.S. Pat. No. 5,242,985 may expose wounds to lower initial iodine levels compared to conventional povidone-iodine, this lower initial level is expected to last for a relatively short time and, as indicated above, cytotoxic levels can be expected to be reached within a few hours.

A preferred iodine/polymer complex for use in the compositions of this invention is a polyvinylpyrrolidone iodine complex, which is described in, for example, U.S. Pat. Nos. 2,706,701; 2,826,532 and 2,900,305 as well as at pp. 1106-1107 of the Tenth Edition of the Merck Index, Published by Merck & Co., Rahway, N.J., USA (1983), the disclosures of which are incorporated herein by reference in their entirety. This complex is commercially available under their name povidone-iodine from BASF, Mt. Olive, N.J., USA.

Zeolites are also a preferred source of antibacterial and antibiofilm cations for purposes of the present invention.

Synthetic zeolites for use in the present methods include zeolites derivatives with dichlorodimethyl silane, ZeoLog-MeTE, ZeoPhob, ZeoLog, ZeoLogCN-METHANOL, Zeolite A (see U.S. Pat. No. 2,882,243); Zeolite B (see U.S. Pat. No. 3,008,803); Zeolite D (see Canada Patent No. 611,981); Zeolite E (see Canada Patent No. 636,931); Zeolite F (see U.S. Pat. No. 2,995,358); Zeolite H (see U.S. Pat. No. 3,010,789); Zeolite J (see U.S. Pat. No. 3,011,869); Zeolite KG (see U.S. Pat. No. 3,056,654); Zeolite L (see Belgium Patent No. 575,117); Zeolite M (see U.S. Pat. No. 2,995,423); Zeolite O (see U.S. Pat. No. 3,140,252); Zeolite Q (see U.S. Pat. No. 2,991,151); Zeolite R (see U.S. Pat. No. 3,030,181); Zeolite S (see U.S. Pat. No. 3,054,657); Zeolite T (see U.S. Pat. No. 2,950,952); Zeolite W (see U.S. Pat. No. 3,012, 853); Zeolite X (see U.S. Pat. No. 2,882,244); Zeolite Y (see U.S. Pat. No. 3,130,007); and Zeolite Z (see Canada Pat. No. 614,995).

Naturally occurring aluminosilicate zeolites that are used in the present methods include analcite, brewsterite, chabazite, clinoptilolite, dachiardite, datolite, erionite, faujasite, ferrierite, flakite, gmelinite, harmotone, heulandite, leucite, levynite, mesolite, mordenite, natrolite, nepheline, noselite, paulingite, phillipsite, scolecite, stilbite, and yugawaralite. Naturally occurring zeolites are preferred. A preferred naturally occurring zeolite is clinoptilolite.

Irrespective of how the cation is complexed, including those complexes described for iodine in U.S. Pat. No. 6,025,446, and for silver in U.S. Pat. Nos. 6,004,667; 4,911,899; 5,244,667 and 4,608,247, the cation complex can be overridden, whereby the cation, rather than flowing on the basis of diffusion, is electromagnetically driven from the bonded permanent magnets of the invention independent of various equilibrium controls traditionally employed to control the concentration of the iodine or silver ion in contact with the bacteria and/or biofilm. The (BH)ₘₐₓ of the bonded magnets of the invention can be used to maintain and control the cytotoxic, cytopathic and/or cytostatic potentials which, uncontrolled, can irritate the wound and significantly retard the healing process, as well as affect fibroblasts involved in the wound repair process. Thus, the (BH)ₘₐₓ can be employed to maintain the iodine cation concentration in contact with the wound below the cytotoxic, cytopathic and cytostatic levels and promote the healing process.

Thus, the bonded permanent magnets of the present invention utilize the antibacterial and antibiofilm efficacy of the various cations contained therein, while minimizing the tissue toxicity and other undesirable side effects that accompany various complexed cations including the iodophors. The antibacterial and antibiofilm bonded permanent magnets of the invention function as controllable reservoirs of antibacterial and antibiofilm cations, controlled by releasing these cations at desirable levels at the site of application for extended periods.

For the purposes of the present invention, a binder is generally described as organic or inorganic materials that have minimal interference with the magnetic properties including (BH)ₘₐₓ.

Bonded magnets with 1-40% binder have been found acceptable for the antibacterial magnets of the present invention. For more details on suitable binders, see U.S. Pat. Nos. 5,888,417; 4,289,549; 5,888,416; 3,982,971; 4,000,982; 4,022,701; 4,081,297; 4,089,995; 4,111,823; 4,121,952; 4,131,495; 5,135,853; 4,192,696; 4,200,547; 4,762,754; 4,717,627; 3,600,748; 4,536,233; 4,931,092; 5,376,291; 5,409,624; 5,405,574; 5,611,230; 5,647,886; 5,689,797 and 5,772,276.

Examples of thermoplastic resins suitable as binders for the antibacterial bonded permanent magnets of the present invention include polyamides such as nylon 4, nylon 6, nylon 66, nylon 612, nylon 11, nylon 12, nylon 6-12, etc., liquid crystal polymers such as aromatic polyesters, polyphenylene oxide, phenylene sulfide, polyolefins, such as polypropylene, modified polyolefins, polycarbonates, polymethylmethacrylate, polyethers, polyetherimides, polyacetals, and copolymers, mixtures and polymer alloys containing the above as the main ingredient. These resins may be used alone or in combination.

Examples of thermosetting resins useful in the antibacterial bonded permanent magnets of the invention include: epoxy resins, phenol resins, urea resins, melamine resins, polyester (unsaturated polyester resins, polyamide resins, silicone resins and polyurethane resins. The foregoing may be used solely or in combination.

Binders suitable for the antibacterial bonded permanent magnets of the invention can also include metal-metal matrix composites as described in detail in Copending patent application, Ser. No. 60/183,941.

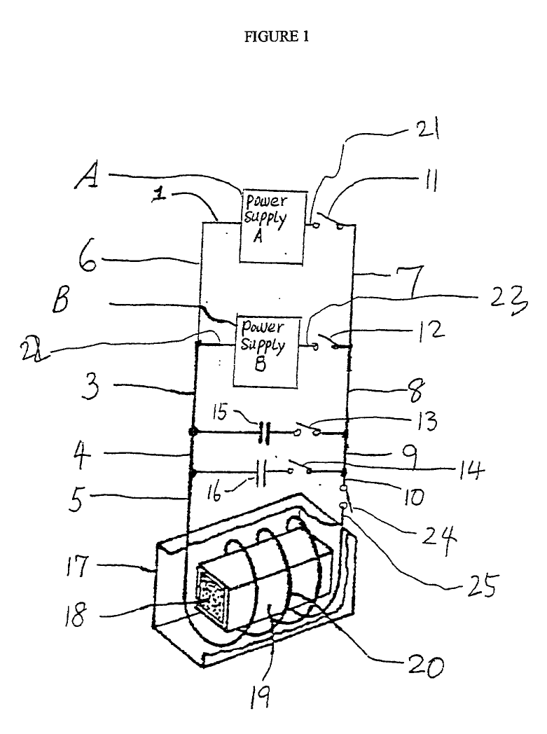

FIG. 1 illustrates a structure and a method for DMC of isotropic and anisotropic bonded magnets with antimicrobial and antibiofilm properties, wherein: A and B represent power supplies connected to conductors 1 and 21 and conductors 22 and 23, respectively. It is understood power supplies A and B can be integrated. Preferably, they are separate power supply systems with the proviso that energy from power supply B is greater than that from supply A.

Conductor 21, via switch 11 is connected to conductor 7, while conductor 23 via switch 12 is connected to conductors 7 and 8. Conductors 3 and 4 and conductors 8 and 9 are connected through capacitor 15 and switch 13. Similarly, conductors 4 and 5 and conductors 9 and 10 are connected through capacitor 16 and switch 14. Conductors 10 and 25 are connected through switch 24.

The conductors 5 and 25 are connected to solenoid or coil 20, which encompasses electrically conductive container 19. The shape and size of the desired DMC bonded permanent magnet determines the size and shape of said electrically conductive container 19. Container 19 may be of any suitable electrically conductive material, such as silver. Coil 20 accommodates the size of container 19. Container 19 holds mixture 18, which represents a mixture of permanent magnet particulate binder and a cationic antibacterial and antibiofilm substance as described below. The mixture fills container 19 and is firmly positioned there within.

The DMC process for isotropic bonded magnets comprises closing switches 23 and 13 with switches 11 and 14 open. Capacitor 15 is charged to capacity by power supply B, after which switch 12 is opened and switch 24 is closed, thereby driving a large quantity of electrical current from capacitor 15 through coil 20. This flow of electrical current applies electromagnetic pressure upon electrically conductive container 19.

This electromagnetic pressure on conductive container 19 reduces transverse dimensions of said container and simultaneously compacts mixture 18 to a dense, DMC compacted, bonded permanent magnet with antibacterial and antibiofilm properties. Depending on the nature of the binder, the resultant magnet can be: (a) cured at appropriate temperatures for thermosetting resin curing, (b) heated to a temperature above the melting point of the thermoplastic binder, provided an inert atmosphere, such as argon or nitrogen is employed, and (c) sintered at a temperature below 400° C. where the binder is inorganic.

The current flowing through coil 20 may be on the order of about 100,000 amperes at a voltage of about 4,000 volts.

The DMC process for anisotropic bonded permanent magnets comprises opening switches 12 and 13, while switches 11 and 14 are closed. Capacitor 16 is charged by power supply A, after which switch 11 is opened and switch 24 is closed, thereby driving electrical current at magnetic alignment levels from capacitor 16 to coil 20. This flow of this lower level of electrical current applies magnetic alignment pressure to container 19 without altering the dimensions of container 19, while magnetically aligning mixture 18. Alignment magnetic fields of at least 30 to about 45 KOₑ are preferred.

After alignment of mixture 18 is achieved, switches 21, 24 and 14 are opened while switches 12 and 13 are closed. Capacitor 15 is thereby charged by power supply B, after which switch 12 is opened and switch 24 is closed driving a large quantity of current from capacitor 15 through coil 20.

This flow of current through coil 20 applies compaction pressure to container 19, reducing the transverse dimensions of container 19, thereby compacting mixture 18 into a high-density, bonded permanent magnet. The resultant magnet is then cured, heat-treated or sintered at temperatures appropriate for thermosetting thermoplastic or inorganic binders. Upon cooling to room temperature, DMC bonded, anisotropic, permanent magnets are manufactured.

It is understood, of course, that other magnitudes of current may be employed as found to be suitable in accordance with the size and physical characteristics of the electrically conductive container 19 and the physical characteristics and volume of the mixture 18. It is also to be understood that when the mixture 18 has good electrically conductive properties the container 19 may not need to be electrically conductive for compaction of the powder-like material in accordance with the method of this invention.

Due to the fact that the coil 20 tends to expand radially as current flows there through, suitable means are employed to restrain the coil 20 against lateral expansion as current flows there through. For example, as shown, container 19 and coil 20 are encompassed by rigid wall 17, which restrains the coil 20 against expansion as current flows there through.

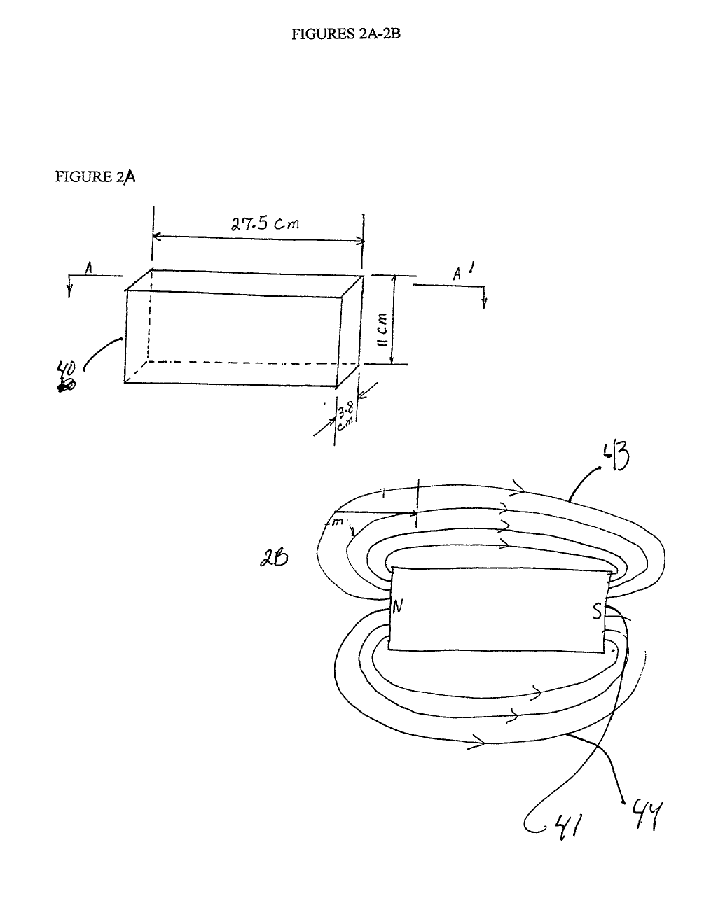

FIGS. 2A and 2B illustrate a perspective of a bonded magnet containing a cationic antibacterial and antibiofilm substance and lateral and linear cross-sectional view thereof taken from line A A′ illustrating flux path.

The bonded magnet 40 illustrated is 27.5 cm in length, 11 cm high and 3.8 cm wide and has a volume of 1149.5 cm³. The flux path is illustrated and designated 43 and 44.

DMC bonded permanent magnets of the invention use pressure generated by pulsed magnetic fields. See U.S. Pat. No. 5,405,574. This process enables ultra-fast compaction (milliseconds) of alloy and/or binder particulates at high energies and desirable temperatures while retaining grain size of the alloy and the properties of the binder. The process is non-contact, having wide tonability in the process parameters (pressure magnitude and duration, temperature and number of pulses), which can be precisely reproduced at a rapid rate. Using DMC, any size of magnetic powders and binders can be consolidated to near full density without altering the structure of the alloy, while also substantially avoiding degradation of the binder and the cationic source of antibacterial and antibiofilm properties.

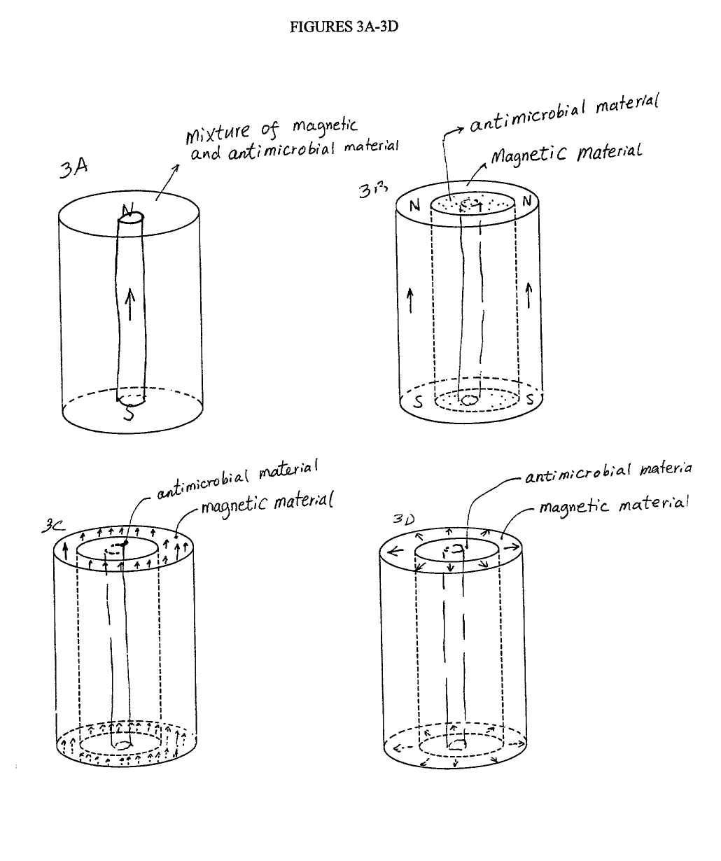

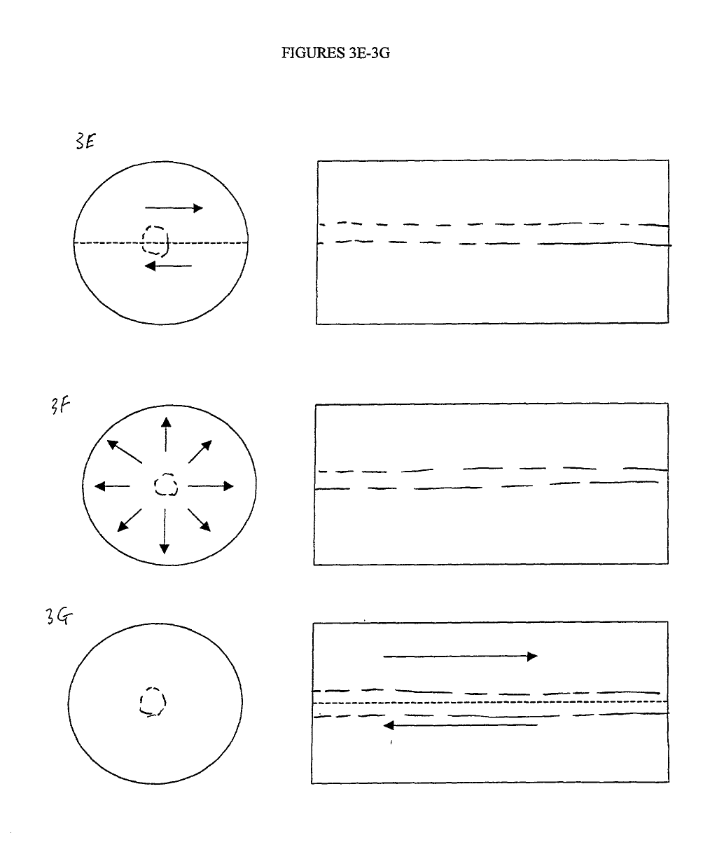

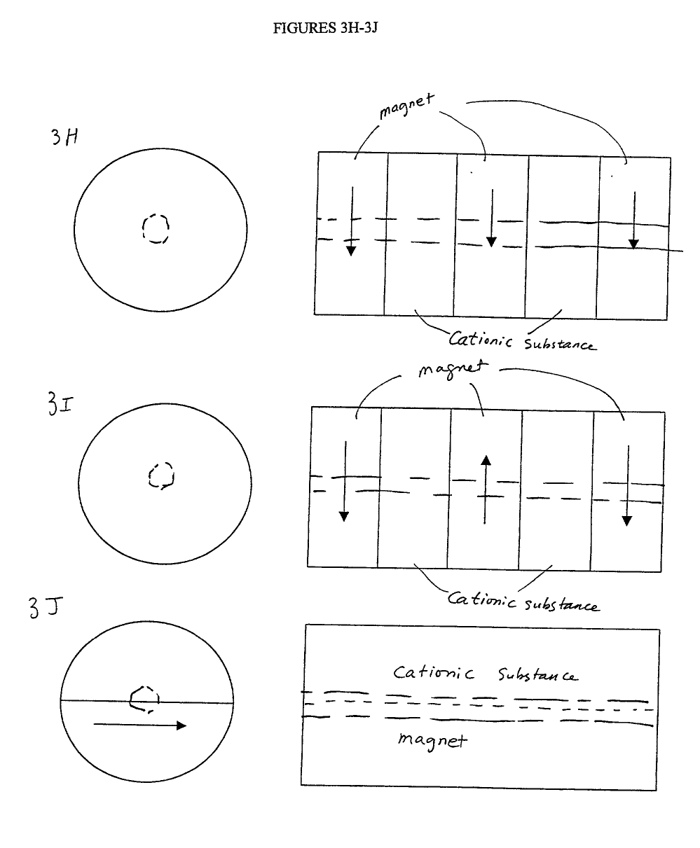

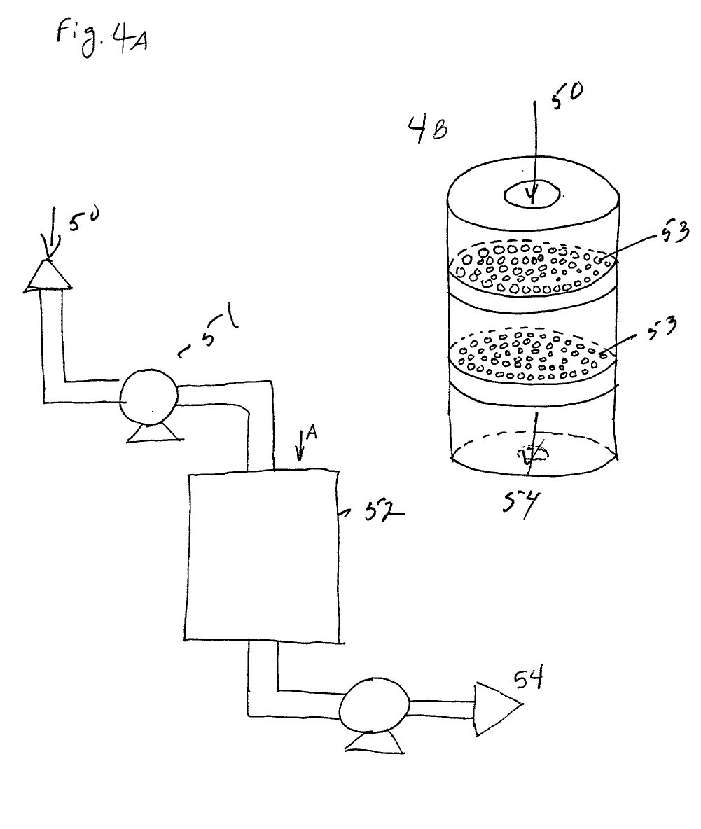

FIGS. 3A through 3J illustrate examples of various medical stents of the invention exhibiting the wide range of magnetic field circuitry and antimicrobial and antibiofilm zones available with the present invention.

FIG. 3A demonstrates magnetization through the length with magnetic poles North and South with flux paths extending between the two poles, N and S.

FIG. 3B illustrates a stent demonstrating a concentric arrangement with the external ring of a bonded magnet. The flux path is indicated extending the length of the bonded magnet between S and N.

FIG. 3C is similar to the concentric arrangement of 3B with the magnet flux path extending through the diameter.

FIG. 3D is similar to 3B and 3C with the magnetic flux path extending radially through the center.

FIG. 3E illustrates the cationic source integral within the magnet with separate halves of the magnet having opposing flux paths through the diameter.

FIG. 3F is similar to FIG. 3E with the magnetic flux path radially aligned.

FIG. 3G is similar to FIG. 3E and 3F, with the magnet flux paths extending through the length in opposing directions.

FIG. 3H illustrates a stent with alternating layers of cationic and magnet particulates with the flux path of the magnet extending through the diameter in each layer.

FIG. 3I is similar to FIG. 3H with the magnet flux paths alternately extending in opposite directions through the diameter.

In FIG. 3J, half of the stent is magnetic particulate with the balance comprising a cationic substance with the flux path extending through the diameter as shown.

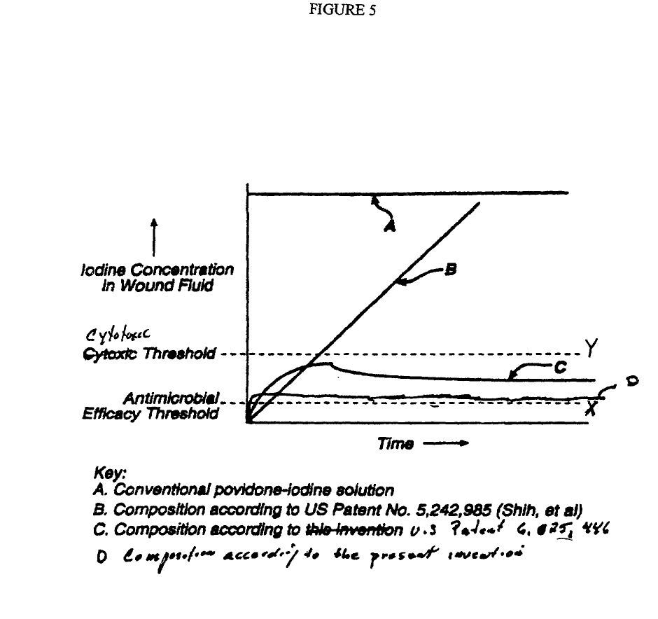

FIGS. 4A to 4B illustrate industrial slime and biofilm control achieved with a bonded permanent magnet 52 arranged in the form of a filter means. The biofilm contaminated fluid 50 is pumped by means 51 into the biofilm control chamber 52 where the biofilm contaminated liquid 50 passes through a series of bonded permanent magnets 53 where antibiofilm cations are released leaving the effluent 54 essentially biofilm free.

FIG. 5 illustrates the control of the cationic antibacterial and antibiofilm substances in a wound using the bonded magnet of the invention. Note: The iodine level of D is maintained between the efficacy threshold X and the cytotoxic threshold Y.

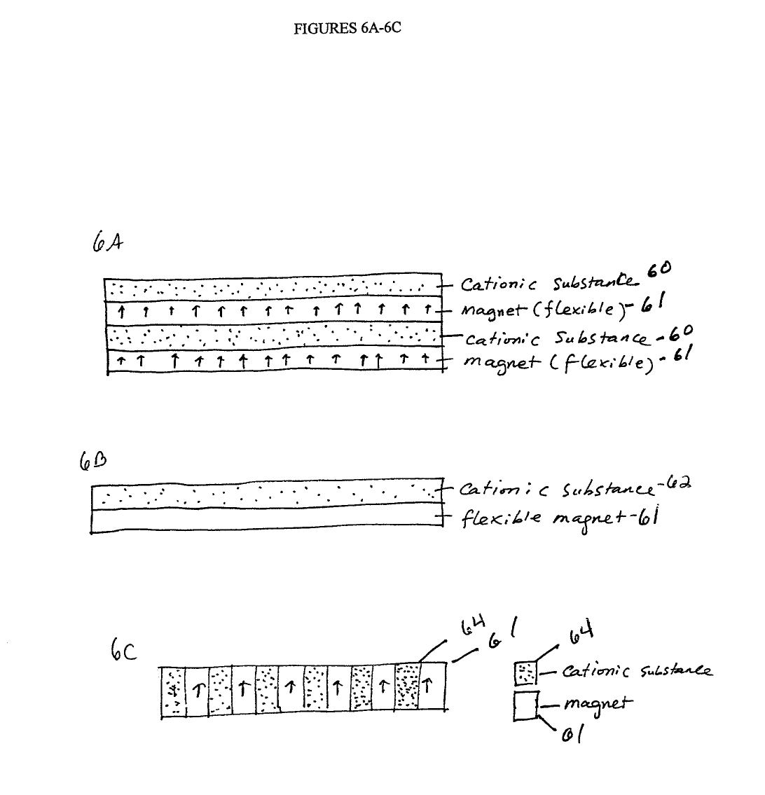

FIGS. 6A through 6C illustrate a series of bonded permanent magnet wraps of the invention where the cationic substrate layers 60, 62 and 64 are separate from the magnet 61 and the magnet flux directs the cationic substance into the area wrapped. The wrap is accompanied with Velcro strips to hold the wraps in place.

The following Examples are illustrative of the invention:

### Example 1

Wound Dressings—Extruded or calendered, flexible, bonded magnet wraps or tapes of the invention can be fabricated containing cationic antibacterial and antibiofilm substances such as iodine or silver using industry standards for these processes. These dressings have multiple benefits when applied to wounds such as the lesions experienced by diabetics.

That is, when applied to such lesions, the antibacterial and antibiofilm dressings of the present invention:

a. create an antimicrobial/antibacterial and antibiofilm zone free from bacteria resistance in the area of the wound with this zone defined by the magnetic field of the bonded permanent magnet,

b. stimulate liquid flow and improve healing, and

c. relieve pain normally indicated by such lesions.

It is proposed that the rate of cationic ion released into the zone is a function of F_{c} and F_{M} as discussed above.

### Example 2

Post Angioplasty Stent Blockage—Stents fabricated from the class of antibacterial and antibiofilm bonded permanent magnets of the invention and described in detail in Drawings 3A to 3J are expected to resist biofilm formation and control inflammatory pathogens including: staphylococcus, chlamydia and mycoplasma, all of which are associated with post angioplasty stent blockage. These antibacterial and antibiofilm bonded permanent magnet stents are expected to reduce post-angioplasty blockage of stents, which is presently indicated in over 20% of angioplasty patients fitted with stents within 12 months of the treatment.

The bonded permanent magnet stents illustrative of the invention maintain their antibacterial/antibiofilm zone:

a. at body temperatures,

b. over a pH range from 3 to 10,

c. in the presence of body fluids, and

d. for the life of the bonded magnets, without creating bacterial resistance.

### Example 3

A stent useful for insertion in blood vessels during an angioplasty procedure is formed using extrusion of a mixture containing permanent magnet particulates and binder with cations in a configuration as illustrated in FIGS. 3D and 3E. Once inserted in the blood vessel, the cations of this bonded permanent magnet stent are expected to inhibit immune system responses, particularly the typical chlamydia and mycoplasma inflammatory responses, which are associated with post-angioplasty blockage. This chlamydia and mycoplasma inhibition is expected to continue for the life of the permanent magnet.

### Example 4

A healing elastomeric wrap containing permanent magnet particulates of nylon 6 binder containing chelated iodine can be prepared by calendering the mixture into a flat wrap less than ⅛ inch thick and about 2 inches wide and approximately 36 inches long.

Should the wrap be secured around the leg of a type 1 diabetic with inflamed lesions on the lower leg, it is expected to accelerate the healing of these lesions while clearing up the inflammation normally indicated by diabetes with inflamed lesions within six to seven days.

### Example 5

A dental appliance, such as a partial or an orthodontic device is fabricated, comprising an antibacterial bonded magnet containing iodine which inhibits the formation of biofilms on said dental appliance over the life of the appliance.

### Example 6

A urinary catheter fabricated from a bonded permanent magnet containing an iodine complex wherein the release of the cation is sufficient to prevent infection (between about 2 and about 5 ppm, but slow enough to maintain the iodine level below the toxicity level for a period of two weeks.

Illustrative Examples of the bonded permanent magnets of the invention are described further in Tables 1 and 2 below.

TABLE 1
Bonded Permanent Magnets with Antibacterial and Antibiofilm Properties
illustrative of the invention are set out below:

| | | Organic | | |
|---|---|---|---|---|
| Cation | Magnetic Powder | Binder | Chelating Agent | Antioxidant |
| Iodine | Sr ferrite powder | PPS | isopropylmalonic | 4,4′butylidene-bis (3- |
| | | | acid | methyl-6-t- |
| | | | | butylphenol |
| Silver | Ba ferrite powder | PEN | phtalic acid | 1,3,5-trimethyl- |
| | | | | 2,4,6-tris(3,5-di-t- |
| | | | | butyl-4- |
| | | | | hydroxybenzyl) |
| | | | | benzene |
| Iodine | SmCo₅-based powder | liquid | diethyltriamine | |
| | | crystalline | | |
| Iodine | Sm₂CO₁₇-based powder | PAG | phenanthroline | |
| Iodine | Nd₂Fe₁₄B-based | Zn | glutamic acid | |
| | powder isotropic melt | | | |
| | spun | | | |
| Iodine | Sm₂Fe₁₇ Ns-based | Cu | glycine | |
| | powder | | | |
| Iodine | NdFeB-type isotropic | Al | phenothiazine | |
| Silver | Anisotropic, NdFeB | Ag | N-salicyloyl-N′- | phenyl-B- |
| | based HDDR process | | aldehydrazine | nephthylamine |
| Silver | Noncrystalline | PEN | N-salicyloyl-N'- | N,N′hexamethylene- |
| | Nd₂Fe₁₄B | | acetylhydrazine | bis(3,5-t-butyl-4- |
| | | | | hydroxy- |
| | | | | hydrocinnamide) |
| Silver | Two-phase | PPS | N,N-bis[3-(3,5-di-t- | |
| | nanocomposite such | | butyl-4 | |
| | as Nd₂Fe₁₄B and | | hydroxyphenyl)]- | |
| | SmCo₅ | | propionylhydrazine | |
| Silver | Sm(Co_{w}FeᵥCuₓZr_{y})_{z} | PAG | N,N- | |
| | | | diphenyloxamide | |
| Silver | Fe_{1 - x}Coₓ | Zn | N,N-hexamethylene | |
| | | | bis | |
| Iodine | Sm₂(FeTM)₁₇Nₓ | Cu | C 3,5-t-butyl-4- | |
| | | | hydroxy- | |
| | | | hydrocinnamide | |
| Iodine | Sm₂(FeTM)₁₇Cₓ | Ag | | |
| Iodine | Sm₂(FeTM)₁₇(C,N)ₓ | Al | | |

TABLE 2
Antibacterial and Antibiofilm Bonded Permanent Magnets Containing Iodine

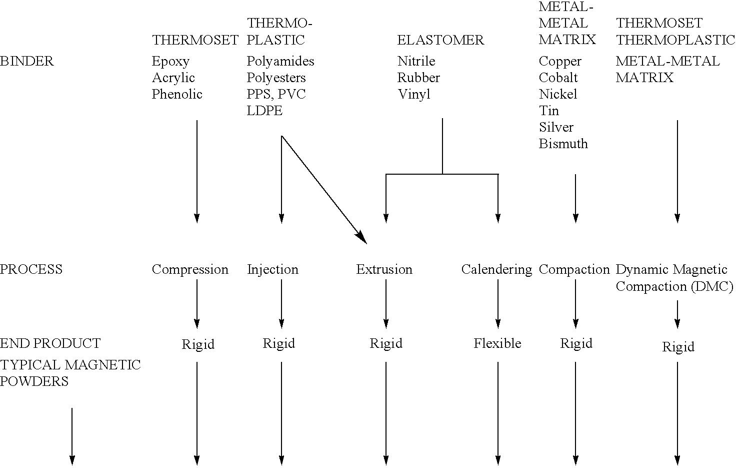

| | | | | | | |
|---|---|---|---|---|---|---|
| NdFeB | 5-10 MGOe | 1-6 | 1-8 | 1-5 | 3-10 | 5-14 MGOe |
| NdFeB (anisotropic) | 5-16 | N/A | N/A | N/A | 3-16 | 5-22 MGOe |
| SmCo₅ | 5-12 | 1-9 | 1-10 | N/A | 3-12 | 5-14 MGOe |
| Sm(CoCuFeZy)₂ | 5-17 | 1-10 | 1-10 | N/A | 3-17 | 5-23 MGOe |
| Ferrite | N/A | 0.5-1.8 | 0.5-1.8 | 0.6-1.8 | N/A | 1-3.5 MGOe |
| Ferrite/NdFeB | N/A | 1-6 | 1-6 | N/A | N/A | 1-14 MGOe |
| hybrids | | | | | | |
| SmFeN | 5-15 | N/A | N/A | N/A | N/A | 5-22 MGOe |

What is claimed is:

1. A class of antibacterial and antibiofilm bonded permanent magnets having (BH)ₘₐₓ up to 99% of theoretical comprising: permanent magnet particulate, binder and a cationic antibacterial and antibiofilm substance responsive to the magnetic field of said magnet.

2. A class of antibacterial and antibiofilm bonded permanent magnets as described in claim 1, where the permanent magnet particulate is selected from the group consisting of alnico, ferrite, samarium cobalt, neodymium-iron-boron and mixtures thereof.

3. A class of antibacterial and antibiofilm bonded permanent magnets as described in claim 1, where the binder is selected from the group consisting of organic and inorganic binders and mixtures thereof.

4. A class of antibacterial and antibiofilm bonded permanent magnets according to claim 1, where the bonded magnet is manufactured using dynamic magnetic compaction and the permanent magnet particulate is isotropic.

5. A class of antibacterial and antibiofilm bonded permanent magnets according to claim 4, where the permanent magnet particulate is anisotropic.

6. A class of antibacterial and antibiofilm bonded permanent magnets according to claim 2, wherein said permanent magnet particulate has the formula RE(Co_{w}Fe_{V}Cu_{X}TM_{Y})_{Z} where the sum of W, V, X and Y is 1 and Z has a value between 5 and 8.5., RE represents a rare earth element selected from the group consisting of Sm, Y, La, Ce, Pr, Na, Gd, Tb, Dy, Ho, Er, and mixtures thereof, and TM is a transition metal selected from the group consisting of Zr, Hf, Ti, Mn, Cr, Nb, Mo W, Ni, Ta, V and mixtures thereof, wherein said antibacterial and antibiofilm bonded permanent magnet exhibits:
a. substantially linear extrinsic demagnetization curves at use-temperatures, and
b. substantially constant antibacterial and antibiofilm properties over the use life of the bonded permanent magnet.

7. A class of antibacterial and antibiofilm bonded permanent magnets according to claim 1, wherein said cationic antibacterial substance is responsive to the magnetic field of said magnet and selected from the group consisting of silver, iodine, copper, zinc, mercury, tin, lead, bismuth, cadmium, chromium cations and mixtures thereof.

8. A class of antibacterial and antibiofilm bonded permanent magnets according to claim 1, wherein said cationic antibacterial and antibiofilm substance is external to said bonded magnet.

9. A class of antibacterial and antibiofilm bonded permanent magnets according to claim 3, wherein the inorganic binder is selected from the group consisting of copper, cobalt, nickel, tin, lead, mercury, silver, gold, platinum, palladium, iridium, rhodium, rhenium, bismuth, silica, silicones and mixtures thereof.

10. A class of antibacterial and antibiofilm bonded permanent magnets according to claim 3, wherein the organic binder is selected from the group consisting of thermoplastic and thermosetting resins and mixtures thereof.

11. A class of antibacterial and antibiofilm bonded permanent magnets according to claim 9, wherein the thermoplastic resin is selected from the group consisting of polyamides, liquid crystal polymers, polyimides, aromatic polyesters, polyphenylene oxides, polyphenylene sulfides, polyolefins, polyethylenes, polypropylenes, modified polyolefins, polycarbonates, polymethylmethacrylates, polyethers, polyetheretherketones, polyetherimides, polyacetals and mixtures thereof.

12. A class of antibacterial and antibiofilm bonded permanent magnets according to claim 9, wherein the thermosetting resin is selected from the group consisting of epoxies, phenols, ureas, melamines, unsaturated polyesters, polyimides, silicones, polyurethanes and mixtures thereof.

13. A method of manufacturing a class of antibacterial and antibiofilm bonded permanent magnets, wherein dynamic magnetic compaction is generated by a pulsed electromagnetic field up to 100 kilo oersteds, for a duration ranging from between about 0.5 milliseconds and about 2 milliseconds.

14. A method of treating a bacterial based condition comprising exposing the source of bacteria to an antibacterial and antibiofilm bonded permanent magnet with enhanced antibacterial and antibiofilm properties, wherein the (BH)ₘₐₓ of said magnet maintains an external flow of antibacterial and antibiofilm cations.

15. A biofilm treatment comprising exposing bacteria hosted in said biofilm to an antibacterial and antibiofilm bonded permanent magnet comprising permanent magnet particulate, binder and a cationic antibacterial and antibiofilm substance responsive to the magnetic field of said bonded permanent magnet.

16. A bacteria resistance-free medical device suitable for controlling bacterial conditions without adverse side affects comprising an antibacterial and antibiofilm bonded permanent magnet comprising permanent magnet particulates, binder and a cationic antibacterial and antibiofilm substance responsive to the magnetic field of said bonded permanent magnet.

17. A biofilm resistant stent suitable for use in angioplasty comprising permanent magnet particulate, binder and cationic iodine, wherein said iodine cations are responsive to the magnetic field of the permanent magnet particulate that has been subjected to dynamic magnetic compaction.

18. An antibacterial and antibiofilm bandage comprising a bonded permanent magnet wrap comprising permanent magnet particulate, binder and cationic iodine, wherein said iodine cations are responsive to the magnetic field of said bonded permanent magnet.

19. A medical implant device that resists biofilm formation and inflammation, manufactured by dynamic magnetic compaction, comprising permanent magnet particulate, binder and cationic antibacterial and antibiofilm substance, wherein said cationic antibacterial and antibiofilm substance is responsive to the magnetic field of said bonded permanent magnet.

20. A class of antibacterial and antibiofilm bonded permanent magnets comprising permanent magnet particulate, binder, a cationic antibacterial substance and a complexing agent for said cationic antibacterial and antibiofilm substance, wherein said magnets control bacteria, biofilms and slime.

21. A method of controlling slime, comprising exposing the slimed surface to an antibacterial and antibiofilm bonded permanent magnet comprising permanent magnet particulate, binder and a cationic antibacterial and antibiofilm substance responsive to the magnetic field of said bonded permanent magnet.
